(19) United States
(12) Patent Application Publication
(10) Pub. No.: US 2019/0351360 A1
(43) Pub. Date: Nov. 21, 2019

(54) PORTABLE HEPA FAN

(71) Applicant: David B. Plotkin, Short Hills, NJ (US)

(72) Inventor: David B. Plotkin, Short Hills, NJ (US)

(21) Appl. No.: 16/249,236

(22) Filed: Jan. 16, 2019

Related U.S. Application Data
(60) Provisional application No. 62/630,563, filed on Feb. 14, 2018.

(51) Int. Cl. B01D 46/24; F24F 1/0071

(52) U.S. Cl. CPC B01D 46/24; B01D 2273/30; F24F 1/0071

(57) ABSTRACT

The present invention provides, in various embodiments, a portable handheld fan comprising a high-efficiency particulate air (HEPA) filter.

### RELATED APPLICATIONS

This application claims the benefit of U.S. Provisional Application No. 62/630,563, filed Feb. 14, 2018, which is incorporated by reference herein in its entirety.

### BACKGROUND

In various situations in which air quality may be poor, consumers may need to take action to improve the quality of the air they breathe. Various air purifiers exist for use in confined spaces such as a room; however, these are typically plugged in and used at home, and are not practical to carry outside or to other places where clean air might be needed, such as an airplane. Various masks exist; however, they may not provide a comfortable fit (e.g., for users who may be claustrophobic) and/or may appear too extreme/conspicuous to use in public.

### SUMMARY

The present invention provides, in various embodiments, a portable handheld fan comprising a high-efficiency particulate air (HEPA) filter.

In some embodiments, the present invention provides a portable HEPA fan configured to be powered by a battery, the fan comprising a fan portion and a handheld portion, wherein the fan portion comprises a back portion comprising fan blades and a back cover; and a front portion comprising a HEPA filter and a collar portion around a circumference of the HEPA filter, the collar portion extending beyond an outer surface of the HEPA filter to direct filtered air from the fan toward a user.

In some embodiments, the fan portion and the handheld portion are connected via a joint.

In some embodiments, the handheld portion includes a power switch configured to turn power ON/OFF and/or change a rotation speed of the fan blades.

In some embodiments, the handheld portion includes a port for connection to a power source for recharging the battery.

In some embodiments, the handheld portion includes a charge indicator comprising a light emitting diode (LED) indicating a charge level.

In some embodiments, the handheld portion includes a power indicator comprising a light emitting diode (LED) indicating whether the power is ON/OFF.

Additional features and advantages of the present invention are described further below. This summary section is meant merely to illustrate certain features of the invention, and is not meant to limit the scope of the invention in any way. The failure to discuss a specific feature or embodiment of the invention, or the inclusion of one or more features in this summary section, should not be construed to limit the invention as claimed.

### BRIEF DESCRIPTION OF THE DRAWINGS

The foregoing summary, as well as the following detailed description of the preferred embodiments of the application, will be better understood when read in conjunction with the appended drawings. For the purposes of illustrating the systems and methods of the present application, there are shown in the drawings preferred embodiments. It should be understood, however, that the application is not limited to the precise arrangements and instrumentalities shown. In the drawings:

FIG. 1 is a perspective view of a portable HEPA fan, according to some embodiments of the invention, in extended form;

FIG. 2 is a front view of the portable HEPA fan of FIG. 1;

FIG. 3 is a back view of the portable HEPA fan of FIG. 1;

FIG. 4 is a perspective view of the portable HEPA fan of FIG. 1, in partially folded form; and

FIG. 5 is a side view of the portable HEPA fan of FIG. 1, in fully folded form.

### DETAILED DESCRIPTION

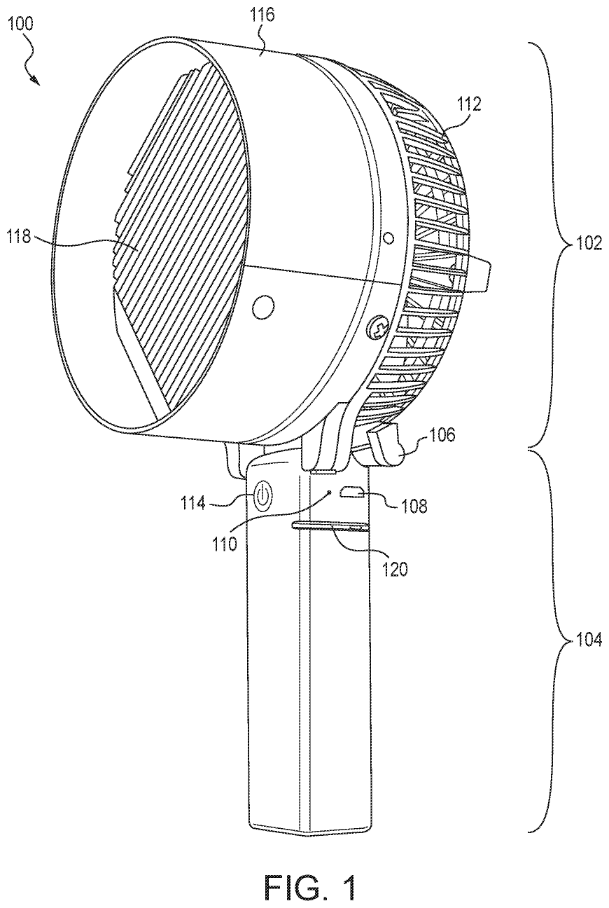

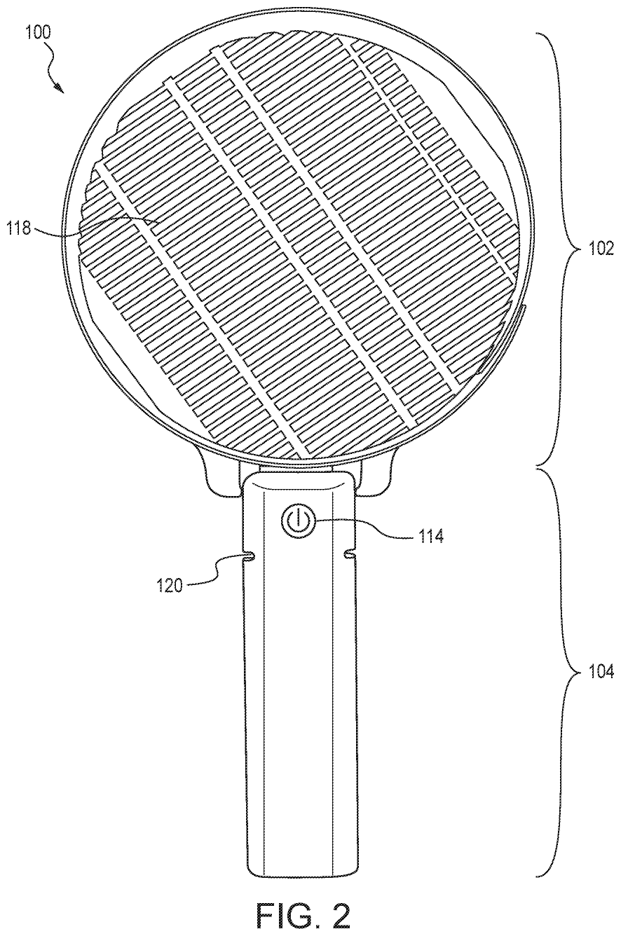

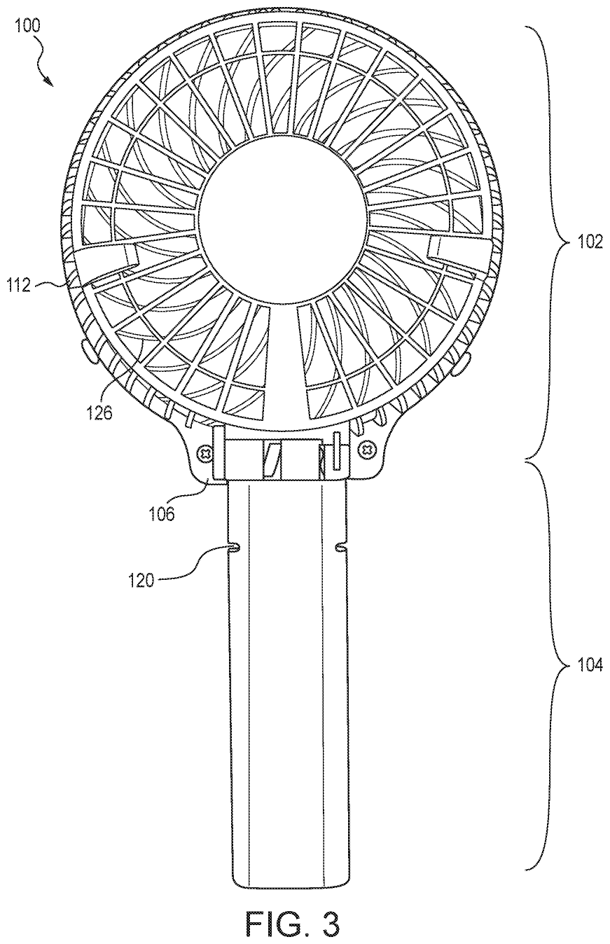

FIGS. 1-5 illustrate a portable HEPA fan 100, according to some embodiments of the invention. Fan 100 comprises a fan portion 102 and a handheld portion 104. In some embodiments, the portable HEPA fan 100 may be battery operated. In some embodiments, the portable HEPA fan 100 may be rechargeable.

On the front of fan portion 102 of fan 100, a HEPA filter 118 is provided. When the power is turned on, fan 100 blows air through the HEPA filter 118, cleaning the air to remove viruses and/or other harmful particles. A collar 116 may be provided around at least a portion of the circumference of HEPA filter 118. At least a portion of collar 116 may extend forward beyond the outer surface of the HEPA filter 118 to direct the filtered air toward the user. A power switch 114 may be provided, for example, on the front of handheld portion 104, to turn the power ON/OFF and/or change the speed of the fan (e.g., Low/Medium/High).

On a first side of handheld portion 104 of fan 100 (e.g., the right side when facing the front of the fan), a port 108 (e.g., USB, micro USB, etc.) may be provided for connection to a power source (outlet, computer, laptop, mobile power supply, etc.) via a cable such as a USB cable (not shown) for recharging the battery. In other embodiments, fan 100 may be, for example, configured to be solar charged. A charge indicator 110, which may comprise, for example, an LED light, may be also included. Charge indicator 110 can, for example, flash when the charge is low, or provide some other indication of the battery charge level. In some embodiments, charge indicator 110 may be red when the battery is charging, and green when the battery is finished charging.

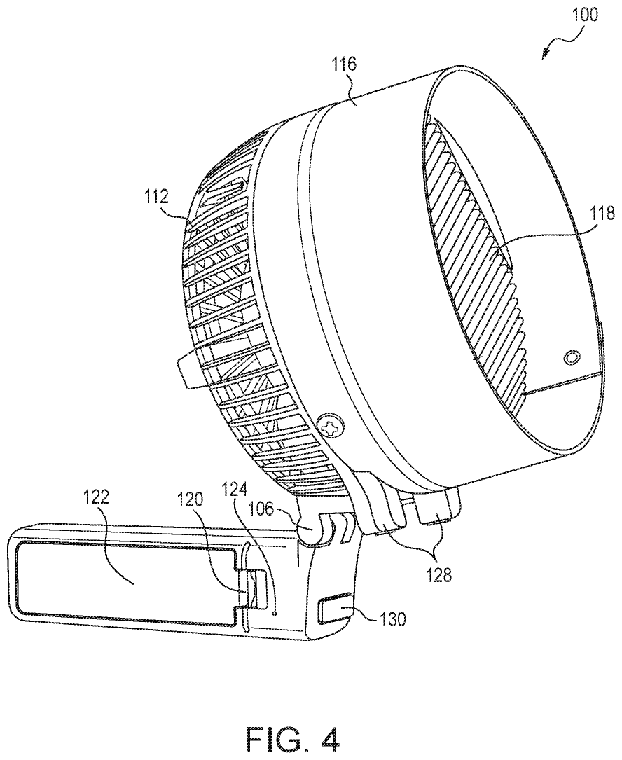

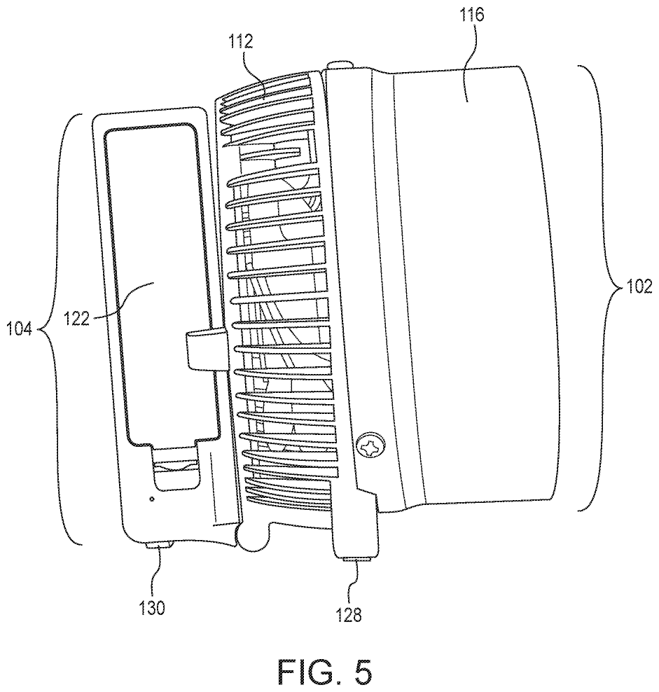

In some embodiments, fan 100 is foldable along a joint 106. Joint 106 is preferably configured so that handheld portion 104 can be fully extended as shown in FIG. 1, so that the fan can be held by the user at any comfortable level/angle; partially bent back as shown in FIG. 4, so that the direction of fan portion 102 can be adjusted while the fan rests on a surface; or fully bent back against the back of the fan portion 102 as shown in FIG. 5, so that the fan can sit upright (e.g., on portions 128 and 130 of fan portion 102 and handheld portion 104, respectively).

In some embodiments, holes/indentions may be provided in slots 120 on both sides of handheld portion 104 of fan 100, into which ends of a metal clip (not shown) may be inserted, so that the fan can be hung/suspended via the metal clip. In some embodiments, handheld portion 104 may comprise an ergonomic shape/design, for example, with ridges and/or textured grips for fingers.

On a second side of fan 100 (e.g., the left side when facing the front of the fan), a battery compartment with a removable cover 122 may be provided, in which a replaceable battery such as an alkaline battery or a Li-ion or other type of rechargeable battery (not shown) can be inserted. A power indicator 124, which may comprise, for example, an LED light, may also be provided, to indicate whether the power is ON/OFF. In some embodiments, power indicator 124 may be lighted (e.g., blue or another color) when the fan is on, and unlighted when the fan is off. On the back of fan portion 102 of fan 100 a cage/cover 112 may be provided, which covers the fan blades 126 and protects the user, while allowing air to flow freely into the fan and through the fan blades 126.

While there have been shown and described fundamental novel features of the invention as applied to the preferred and exemplary embodiments thereof, it will be understood that omissions and substitutions and changes in the form and details of the disclosed invention may be made by those skilled in the art without departing from the spirit of the invention. Moreover, as is readily apparent, numerous modifications and changes may readily occur to those skilled in the art. For example, any feature(s) in one or more embodiments may be applicable and combined with one or more other embodiments. Hence, it is not desired to limit the invention to the exact construction and operation shown and described and, accordingly, all suitable modification equivalents may be resorted to falling within the scope of the invention as claimed. It is the intention, therefore, to be limited only as indicated by the scope of the claims appended hereto.

What is claimed is:

1. A portable HEPA fan configured to be powered by a battery, the fan comprising a fan portion and a handheld portion, wherein the fan portion comprises a back portion comprising fan blades and a back cover; and a front portion comprising a HEPA filter and a collar portion around a circumference of the HEPA filter, the collar portion extending beyond an outer surface of the HEPA filter to direct filtered air from the fan toward a user.

2. The portable HEPA fan of claim 1, wherein the fan portion and the handheld portion are connected via a joint.

3. The portable HEPA fan of claim 1, wherein the handheld portion includes a power switch configured to turn power ON/OFF and/or change a rotation speed of the fan blades.

4. The portable HEPA fan of claim 1, wherein the handheld portion includes a port for connection to a power source for recharging the battery.

5. The portable HEPA fan of claim 1, wherein the handheld portion includes a charge indicator comprising a light emitting diode (LED) indicating a charge level.

6. The portable HEPA fan of claim 1, wherein the handheld portion includes a power indicator comprising a light emitting diode (LED) indicating whether the power is ON/OFF.
